(19) United States
(12) Patent Application Publication
(10) Pub. No.: US 2014/0122257 A1
(43) Pub. Date: May 1, 2014

(54) APPARATUS AND METHOD FOR INTERFACING WITH A PLURALITY OF PUBLISHERS

(71) Applicant: TAYKEY LTD., Herzliya (IL)

(72) Inventors: Amit AVNER, Herzliya (IL); Omer DROR, Tel Aviv (IL)

(73) Assignee: Taykey Ltd., Herzliya (IL)

(21) Appl. No.: 13/860,276

(22) Filed: Apr. 10, 2013

Related U.S. Application Data
(60) Provisional application No. 61/720,529, filed on Oct. 31, 2012.

(51) Int. Cl. G06Q 30/02

(52) U.S. Cl. CPC G06Q 30/0277
USPC 705/14.73; 705/14.4

(57) ABSTRACT

A computerized method, apparatus and system for interfacing with one or more advertisement publishers across a network. The method includes receiving an advertisement and associated metadata from a client node over the network using a general purpose application programming interface (GPAPI); determining a list of recommended publishers for the advertisement based on at least the advertisement and the associated metadata; and placing the advertisement with one or more publisher nodes of publishers selected out of the recommended publishers, wherein communication with each publisher node of the selected publishers is performed using an application programming interface (API) of a respective publisher node.

### CROSS-REFERENCE TO RELATED APPLICATIONS

This application claims the benefit of U.S. provisional application No. 61/720,529 filed on Oct. 31, 2012, the contents of which are herein incorporated by reference.

### TECHNICAL FIELD

A system and methods for managing an advertising campaign, and more specifically a system and methods for interfacing with a plurality of publishers using an application programming interface (API).

### BACKGROUND

The ubiquity of access availability to information using the Internet and the worldwide web (WWW), within a short period of time, and by means of a variety of access devices, has naturally drawn the focus of advertisers. The advertisers may pay publishers such as search engines, for example, Google® or Yahoo!®, for the placement of their advertisement when a related keyword to an advertisement is submitted by a user for a search. Other publishers may be social networks, such as Facebook®, Google+®, and Linked In® that further allow placement of advertisements for a fee.

Each of the advertisement publishers provides a unique application programming interface (API) through which a user wishing to place an advertisement, or bidding for a placement respective thereof, is expected to use. As on-line advertising continuously changes and develops, with more publishers becoming available and with many different types of APIs, it has become difficult to efficiently communicate with such publishers. Even more so, it has become difficult to track the performance of a campaign with one publisher or to compare and contrast campaign performances among different publishers.

It would be therefore advantageous to overcome the limitations of the prior art by providing an effective way to interface with a plurality of publishers preferably through a single API.

### SUMMARY

Certain embodiments disclosed embodiments include a computerized method for interfacing with one or more publishers across a network. The method comprises receiving an advertisement and associated metadata from a client node over the network using a general purpose application programming interface (GPAPI); determining a list of recommended publishers for the advertisement based on at least the advertisement and the associated metadata; and placing the advertisement with one or more publisher nodes of publishers selected out of the recommended publishers, wherein communication with each publisher node of the selected publishers is performed using an application programming interface (API) of a respective publisher node.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system in accordance with one embodiment;

FIG. 2 is a schematic diagram illustrating an application programming model provided in accordance with one embodiment; and,

FIG. 3 is a flowchart describing the operation of the system in accordance with one embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein include a system and method allowing a user to interact simultaneously with a plurality of publishers using a single application program interface (API). In one exemplary embodiment, the system transforms an advertisement received for placement so that the advertisement can be provided to each of a plurality of publishers according to each publisher's unique API requirements. In one embodiment, by analyzing the plurality of the received advertisements with respect of the plurality of publishers, the system generates a recommendation of one or more publishers of the plurality of publishers that would best suit the need of an advertisement.

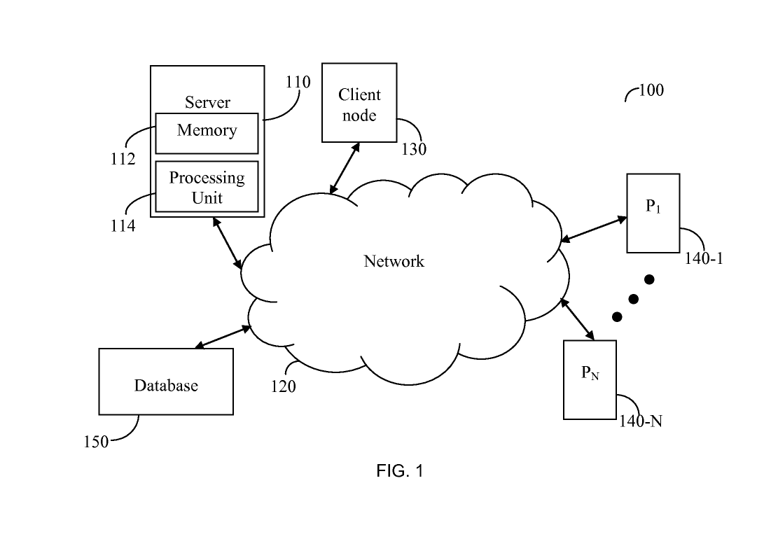

FIG. 1 depicts an exemplary and non-limiting schematic diagram of a system 100 utilized to describe the various disclosed embodiments. A server 110, such as, but not limited to, a computer comprising of a processing unit 112 which is connected to an internal memory 114, where the server 110 is connected to a network 120. The network 120 can be, for example, wired or wireless, a local area network (LAN), a wide area network (WAN), a metro area network (MAN), the Internet, the worldwide web (WWW), and the like, and any combinations thereof. In one embodiment, the memory 114 contains instructions that when executed by the processing unit 112, causing the server 110 to be configured to perform the functions described herein below.

According to one embodiment, the server 110 receives an advertisement and an associated metadata from a client node, for example, a client node 130, using a general purpose API (GPAPI) by way of network 120. The associated metadata may be, for example, but not by way of limitation, budget constraints, preferred publishers, preferred publishing times, preferred geographical locations, and preferred demography, or exclusions thereof.

The client node 130 may be, for example, a personal computer (PC), a laptop computer, a mobile device as part of an advertising agency that provides ads for uploads as part of an on-line campaign. It should be noted that many ads for the same on-line campaign or for different campaigns can be provided by one or more agencies. It should be understood that while a single client node 130 is shown in FIG. 1, this should not be viewed as limiting the scope of the disclosed embodiments, and one of ordinary skill in the art would readily appreciate that additional client nodes can be added without departing from the spirit and/or scope of the invention.

Based in part on the received metadata, the server 110 provides one or more recommendations for one or more publishers 140 deemed appropriate for the advertisement provided by the client node 130. In one embodiment, the recommended publishers 140 may be determined by the server 110 only based on the received metadata.

To generate the recommendations to be provided to the client node 130, the server 110 is configured with a plurality of publisher parameters characterizing each publisher 140. Specifically, for publisher 140, the parameters characterize at least a targeted demographic audience of the publisher as well as the cost for publishing an advertisement at different geographical locations and at different times. The server 110 calculates a matching score for each publisher based, in part, on at least one of a plurality of parameters related to the publisher, the advertisement, the associated metadata, and historical data. The historical data may include, for example which publisher serves a certain category of advertisements and/or advertising agencies. The matching score defines how likely the publisher is to efficiently serve the user of node 130's advertising goals based on given the preferences and constraints set by the metadata.

As a non-limiting example, the metadata defined a budget of 1 million dollars for publishing an ad in the US and Canada during the months of April and May for a demographic audience of teenagers. The server 110, based on the publisher parameters, computes a reach score for each publisher that ascertains the reach of the publisher to teenagers, for example, a high score is a good reach, whereas a low score is a low reach. The cost score is calculated to provide an indication of how costly it would be to publish an advertisement through a particular publisher for the requested location and duration. The server 110 can also calculate the cost for advertising the ad through the particular publisher and filter out those publishers that do not meet the budget. In one embodiment, the matching score is then computed as a weighted sum of the reach score and the cost score. The weights may be set based on the importance of the reach and cost to the user of the client node 130. As a default the weights are set to 1.

The server 110 selects the top publishers that received the highest matching scores as the recommended publisher or publishers. Thereafter, the recommended publisher(s) are sent to the client node 130.

A user of the client node 130 selects one or more publishers from the recommended publishers. The selected publishers are sent to the server 110 through the GPAPI. The selected publishers may be sent to server 110 together with instructions as to which publishers to use for different locations and/or times.

Upon receipt of the selected publishers, the server 110 publishes the advertisement through an API of each of the selected publishers. Each of the selected publishers has its own API. The GPAPI allows interaction of all client nodes 130 with the server 110. The server 110 interacts with the publishers' through their respective API. The published advertisement together with its respective metadata may be saved in a data warehouse, for example the database 150. Therefore all client nodes 130 can publish ads through the server 110 by implementing a single GPAPI, which is utilized by the client nodes 130. The server 110 interfaces with each publisher node 140-1 to 140-N using the specific API required by the publisher. The publishers may be web servers configured to display one or more advertisements. Such web servers may be search engines, for example, Google®, Facebook®, Bing®, and so on. All data respective of the published advertisement may be saved in a database 150. Advantageously, the client node 130 or nodes do not need to utilize each individual API of each individual publisher.

In another embodiment, the selection of the publisher nodes 140 to be afforded the advertisements for placements are automatically selected by the server 110 without further intervention by a user of the client node 130.

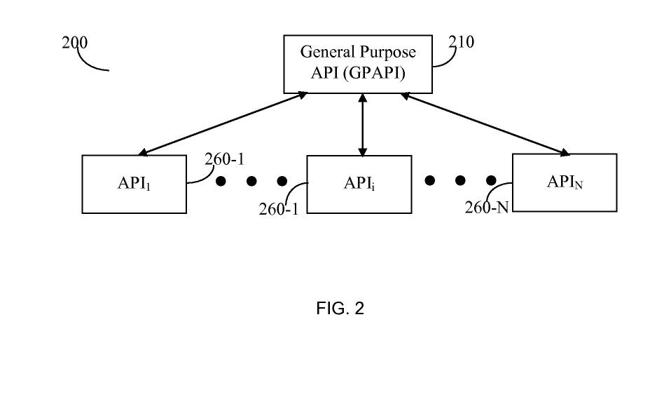

FIG. 2 is an exemplary and non-limiting schematic diagram 200 showing the application programming model in accordance with an embodiment. In order to overcome the prior art limitation of the need of knowledge of the API of each and every publisher 140, the GPAPI 210 is provided, through which a client node 130 can place an advertisement. In one embodiment the GPAPI 210 is implemented in the server 110 and configured to receive requests for placement of advertisements which include the advertisement itself and metadata associated thereto from client nodes, for example, the client node 130, and responsively, after determining to which of the publisher nodes 140-1 through 140-N to place the advertisement with, to use the respective APIs 260-1 through 260-N to interface with each of the publisher nodes 140 selected for advertisement placement. For example, if the publisher nodes 140-1 and 140-N are selected then the GPAPI 210 communicates with the publisher nodes 140-1 and 140-N through their respective APIs 250-1 and 260-i. Therefore, the GPAPI provides a singular tool for the client nodes, enabling them to interact with a plurality of publisher nodes 140-1 through 140-N with a singular interface.

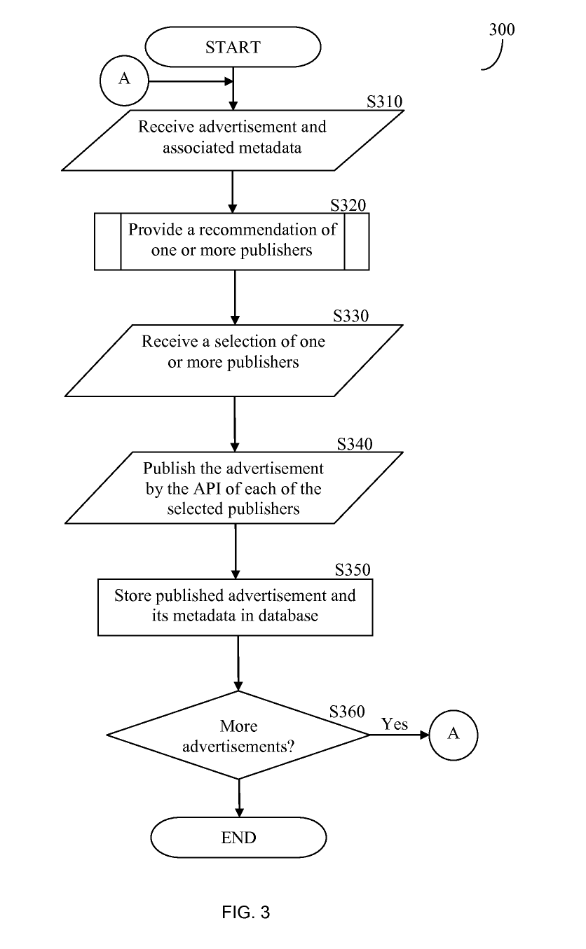

FIG. 3 depicts an exemplary and non-limiting flowchart 300 describing the operation of the system in accordance with an embodiment. In S310, a server, for example the server 110, receives an advertisement and associated metadata from a client node, for example, the client node 130. The client node 130 communicates with the server 110 through the GPAPI. In S320, the server provides a recommendation for one or more publishers deemed appropriate for the advertisement based in part on the associated metadata. A process for determining the recommended publishers for the client 130, according to one embodiment, is discussed in detail above. In S325, the list of recommended publishers as determined by the server 110 is sent to the client node 130 through the GPAPI. In response, a user of the client node, e.g., a campaign manager selects which of the recommended publishers to use and when to use them for advertising of the advertisement received in in S310. In S330, the selections made by the user of the client node are received at the server 110. In another embodiment the selection of the appropriate publishers out of the recommended publisher may be made by the server 110.

In S340 the advertisement is published by the API of each of the selected publishers. As noted above, APIs of different publishers are different by nature. The GPAPI is being generated in order to allow the client node 130 to interact with selected publishers through a single interface of the GPAPI, such interaction is performed through the server 110. That is, the client node 130 implements only the GPAPI and not the respective APIs of the different publisher servers.

In optional S350 the published advertisement together with its respective metadata is saved in data warehouse, for example the database 150. The published advertisement may be, for example, data respective of the placement of the advertisement, i.e., time, place, cost, etc. In S360 it is checked whether there are more advertisements and if so, execution continues with S310; otherwise, execution terminates.

The various embodiments disclosed herein may be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture, such as the server 110 or even the client node 130 or distributed there-between. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What we claimed is:

1. A computerized method for interfacing with one or more publishers across a network comprising:
receiving an advertisement and associated metadata from a client node over the network using a general purpose application programming interface (GPAPI);
determining a list of recommended publishers for the advertisement based on at least the advertisement and the associated metadata; and
placing the advertisement with one or more publisher nodes of publishers selected out of the recommended publishers, wherein communication with each publisher node of the selected publishers is performed using an application programming interface (API) of a respective publisher node.

2. The method of claim 1, further comprising:
sending to the client node over the network using the GPAPI the list of recommended publishers; and
receiving from the client node a selection of the publishers for placing the advertisement.

3. The method of claim 1, wherein the determination of the list of recommended publishers further comprising:
calculating a matching score for a group of publishers,
determining the recommended publishers based upon matching scores of the group of publishers.

4. The method of claim 3, wherein the calculation of the matching score is made based on at least one of: a plurality of publisher parameters characterizing each publisher, the advertisement, the associated metadata, and historical data.

5. The method of claim 1, wherein the client node is one of: a personal computer (PC), a laptop computer, a mobile device.

6. The method of claim 1, wherein the associated metadata is at least one of:
budget constraints, preferred publishers, preferred times, and preferred demography.

7. The method of claim 1, wherein the associated metadata includes exclusions of at least one of: budget constraints, preferred publishers, preferred times, and preferred demography.

8. The method of claim 1, further comprising:
storing data related to the published advertisement and its respective metadata in a data warehouse.

9. The method of claim 1, wherein the publisher nodes are web servers configured to display one or more advertisements.

10. A non-transitory computer readable medium having stored thereon instructions for causing one or more processing units to execute the method according to claim 1.

11. A system comprising:
one or more processing units; and
one or more memory units coupled to the one or more processing units, wherein at least one of the one or more memory units storing therein instructions for causing one or more processing units to perform the steps of:
receiving an advertisement and associated metadata from a client node over a network using a general purpose application programming interface (GPAPI);
determining a list of recommended publishers for the advertisement based on at least the advertisement and the associated metadata; and
placing the advertisement with one or more publisher nodes of publishers selected out of the recommended publishers, wherein communication with each publisher node of the selected publishers is performed using an application programming interface (API) of a respective publisher node.

12. An apparatus for interfacing one or more publishers, comprising:
an interface to a network for receiving and sending data over the network;
a processing unit coupled to the network via the interface;
a general purpose application programming interface (GPAPI); and
a memory coupled to the processing unit and that contains therein instructions that when executed by the processing unit configures the apparatus to: receive an advertisement and associated metadata from a client node over the network using the GPAPI, determine a list of recommended publishers for the advertisement based on at least the advertisement and the associated metadata, and place the advertisement with publisher nodes of publishers selected out of the recommended publishers wherein communication with each publisher node of the selected publishers is performed using an application programming interface (API) of respective publisher node.

13. The apparatus of claim 12, wherein apparatus is further configured to send to the client node the list of recommended publishers and receive from the client node selection of the publishers.

14. The apparatus of claim 12, wherein the determination of the list of recommended publishers further comprises: calculating a matching score for each publisher of the recommended publishers.

15. The apparatus of claim 14, wherein the calculation of the matching score is made based on at least one of: a plurality of publisher parameters characterizing each publisher, the advertisement, the associated metadata, historical data, a combination thereof, a portion thereof.

16. The apparatus of claim 12, wherein the client node is one of: a personal computer (PC), a laptop computer, a mobile device.

17. The apparatus of claim 12, wherein the associated metadata is at least one of:
budget constraints, preferred publishers, preferred times, and preferred demography.

18. The apparatus of claim 12, wherein the associated metadata includes exclusions of at least one of: budget constraints, preferred publishers, preferred times, and preferred demography.

19. The apparatus of claim 12, further comprises:
a database coupled to the network.

20. The apparatus of claim 19 wherein the memory further contains instructions to configure the apparatus to store data related to the published advertisement and its respective metadata in the database.

21. The apparatus of claim 12, wherein the publisher nodes are web servers configured to display one or more advertisements.
